(19) United States
(12) Patent Application Publication
(10) Pub. No.: US 2025/0356736 A1
(43) Pub. Date: Nov. 20, 2025

(54) PRIZE-ACQUISITION GAME DEVICE

(71) Applicant: SEGA CORPORATION, Tokyo (JP)

(72) Inventors: Riho Takikawa, Tokyo (JP); Mitsuharu Fukazawa, Tokyo (JP); Takaya Goshozono, Tokyo (JP); Asako Tominaga, Tokyo (JP); Momoko Fukunaga, Tokyo (JP); Yuuki Hanafusa, Tokyo (JP)

(73) Assignee: SEGA CORPORATION, Tokyo (JP)

(21) Appl. No.: 19/292,021

(22) Filed: Aug. 6, 2025

Related U.S. Application Data
(63) Continuation of application No. PCT/JP2023/041539, filed on Nov. 17, 2023.

(30) Foreign Application Priority Data
Feb. 6, 2023 (JP) 2023-016481

(51) Int. Cl. G07F 17/32; A63F 9/30

(52) U.S. Cl. CPC G07F 17/3297; A63F 9/30; G07F 17/3216; G07F 17/3223; G07F 17/3272; G07F 17/3209; G07F 17/3211

(57) ABSTRACT

A prize acquisition game device includes: a fixed rail; a first moving rail supported by the fixed rail and movable along the left-right direction in a first play area; a first prize catcher supported by the first moving rail; a first light shielding tool supported by the fixed rail and movable along the left-right direction; a first optical sensor attached to the first moving rail and detecting a right end position of the first play area; a second moving rail supported by the fixed rail and movable along the left-right direction in a second play area; a second prize catcher supported by the second moving rail; a second light shielding tool supported by the fixed rail and movable along the left-right direction; and a second optical sensor attached to the second moving rail and detecting a left end position of the second play area.

### BACKGROUND

### Technical Field

The present invention relates to a prize acquisition game device.

### Description of Related Art

There are known prize acquisition game devices that cause a player to play a game to obtain a prize housed in a housing space for the prize (for example, Patent Document 1).

### PATENT DOCUMENTS

[Patent Document 1] JP 2019-98076 A

### Technological Problem to Be Solved by Invention

The prize acquisition game device described in Patent Document 1 forms a first play area on the left side of a housing space where a player plays a prize acquisition game, and forms a second play area on the right side of the housing space. In the first play area a first prize acquisition section is movable, and in the second play area a second prize acquisition section is movable. Since the first play area and the second play area are the same size, the range of movement of the first prize acquisition section and the second prize acquisition section within the housing space is also the same size. Since the size of the first play area and the second play area cannot be changed, the size of the movable range within the housing space of the first prize acquisition section and the second prize acquisition section cannot be changed either. On the other hand, a service provider (for example, a store clerk or the like) may want to change the play area to different sizes on the left and right sides to allow for a variety of game play depending on the type and size of the prizes within the housing space.

### SUMMARY

One or more embodiments of the present invention have the sizes of the first play area and the second play area be changeable.

According to one aspect of the present invention, a prize acquisition game device comprises: a fixed rail that extends in a left-right direction across a left-hand first play area and a right-hand second play area adjacent to each other in a housing space housing a prize; a first moving rail that extends in a front-back direction orthogonal to the left-right direction and is supported by the fixed rail to be movable along the left-right direction in the first play area; a first prize catcher that comprises an arm and is supported by the first moving rail to be movable along the front-back direction; a first light shielding tool that is supported by the fixed rail to be movable along the left-right direction; a first optical sensor that is attached to the first moving rail and detects the first light shielding tool at a right end position of the first play area; a second moving rail that extends in the front-back direction and is supported by the fixed rail to be movable along the left-right direction in the second play area; a second prize catcher that comprises an arm and is supported by the second moving rail to be movable along the front-back direction; a second light shielding tool that is supported by the fixed rail to be movable along the left-right direction; and a second optical sensor that is attached to the second moving rail and detects the second light shielding tool at a left end position of the second play area, wherein the first light shielding tool is supported by the fixed rail at a position after movement between the first moving rail and the second light shielding tool such that the right end position of the first play area is changeable, and the second light shielding tool is supported by the fixed rail at the position after movement between the first light shielding tool and the second moving rail such that the left end position of the second play area is changeable.

Other features of the present invention will become apparent from the specification and the accompanying drawings.

### BRIEF DESCRIPTION OF DRAWINGS

FIG. 1 is an external view illustrating a configuration of a prize acquisition game device 1 according to one or more embodiments.

FIG. 2 is a schematic perspective view illustrating a configuration of a prize acquisition game device 1 according to one or more embodiments.

FIG. 3 is a block diagram illustrating a configuration of a prize acquisition game device 1 according to one or more embodiments.

FIG. 4 is a schematic diagram illustrating a configuration of a prize acquisition unit 20 according to one or more embodiments.

FIG. 5 is a schematic perspective view illustrating a configuration of a moving unit 50 according to one or more embodiments.

FIG. 6 is a planar perspective view illustrating a configuration of a moving unit 50 according to one or more embodiments.

FIG. 7 is a right planar perspective view illustrating a configuration of a moving unit 50 according to one or more embodiments.

FIG. 8 is a schematic perspective view illustrating a configuration of a first right end operation unit 532 according to one or more embodiments.

FIG. 9 is a schematic perspective view illustrating a configuration of a second left end operation unit 533 according to one or more embodiments.

FIG. 10 is a diagram illustrating a state in which the first right end operation unit 532 and the second left end operation unit 533 have been moved to the right.

FIG. 11 is a diagram illustrating a state in which the first right end operation unit 532 has been moved to the left and the second left end operation unit 533 has been moved to the right.

FIG. 12A is a diagram explaining the settings of the play areas and illustrating a state in which a first play area PA1 and a second play area PA2 are set to the same size.

FIG. 12B is a diagram explaining the settings of the play areas and illustrating a state in which the second play area PA2 is set to be smaller than the first play area PA1.

FIG. 12C is a diagram explaining the settings of the play areas and illustrating a state in which a display area DA is set between the first play area PA1 and the second play area PA2.

FIG. 13 is a flowchart explaining operation examples of the prize acquisition game device 1 according to one or more embodiments.

FIG. 14 is a schematic perspective view illustrating a configuration of an operation unit 535 according to one or more embodiments.

### DETAILED DESCRIPTION OF EMBODIMENTS

At least the following will become apparent from the description of this specification and the accompanying drawings.

That is, a prize acquisition game device comprises: a fixed rail that extends in a left-right direction across a left-hand first play area and a right-hand second play area adjacent to each other in a housing space housing a prize; a first moving rail that extends in a front-back direction orthogonal to the left-right direction and is supported by the fixed rail to be movable along the left-right direction in the first play area; a first prize catcher that comprises an arm and is supported by the first moving rail to be movable along the front-back direction; a first light shielding tool that is supported by the fixed rail to be movable along the left-right direction; a first optical sensor that is attached to the first moving rail and detects the first light shielding tool at a right end position of the first play area; a second moving rail that extends in the front-back direction and is supported by the fixed rail to be movable along the left-right direction in the second play area; a second prize catcher that comprises an arm and is supported by the second moving rail to be movable along the front-back direction; a second light shielding tool that is supported by the fixed rail to be movable along the left-right direction; and a second optical sensor that is attached to the second moving rail and detects the second light shielding tool at a left end position of the second play area, wherein the first light shielding tool is supported by the fixed rail at a position after movement between the first moving rail and the second light shielding tool such that the right end position of the first play area is changeable, and the second light shielding tool is supported by the fixed rail at the position after movement between the first light shielding tool and the second moving rail such that the left end position of the second play area is changeable.

According to this type of prize acquisition game device, a service provider (for example, a store clerk or the like) can individually change the size of the first play area and the second play area by adjusting the positions of each of the first light shielding tool and the second light shielding tool along the fixed rail in the left-right direction.

Furthermore, such a prize acquisition game device may be provided with a control unit that stops the first moving rail at the right end position of the first play area in response to the first optical sensor detecting the first light shielding tool after movement of the first moving rail along the left-right direction; and the control unit stops the second moving rail at the left end position of the second play area in response to the second optical sensor detecting the second light shielding tool after movement of the second moving rail along the left-right direction.

According to this type of prize acquisition game device, the movable range of the first prize catcher can be limited in correspondence with the first play area, and the movable range of the second prize catcher can be limited in correspondence with the second play area.

Furthermore, in such a prize acquisition game device, the fixed rail defines a non-play area between the first play area and the second play area by supporting the first light shielding tool and the second light shielding tool to open an interval from the right end position of the first play area to the left end position of the second play area. According to this type of prize acquisition game device, the service provider can form not only a play area but also a non-play area within the housing space by adjusting the distance between the first light shielding tool and the second light shielding tool in the left-right direction.

In addition, in such a prize acquisition game device, the fixed rail supports the first light shielding tool and the second light shielding tool in a sliding manner along the left-right direction, and the first light shielding tool and the second light shielding tool are positioned on the fixed rail by a magnet at positions after slide movement.

According to this type of prize acquisition game device, the service provider can determine the left-right positions of each of the first light shielding tool and the second light shielding tool with a simple operation.

Furthermore, a prize acquisition game device is provided with: a fixed rail that extends in a left-right direction across a left-hand first play area and a right-hand second play area adjacent to each other in a housing space housing a prize; a first moving rail that extends in a front-back direction orthogonal to the left-right direction and is supported by the fixed rail to be movable along the left-right direction in the first play area; a first prize catcher that comprises an arm and is supported by the first moving rail to be movable along the front-back direction; a second moving rail that extends in the front-back direction and is supported by the fixed rail to be movable along the left-right direction in the second play area; a second prize catcher that comprises an arm and is supported by the second moving rail to be movable along the front-back direction; and a light shielding tool that is supported by the fixed rail to be movable along the left-right direction; a first optical sensor that is attached to the first moving rail and detects the light shielding tool at a boundary position between the first play area and the second play area; and a second optical sensor that is attached to the second moving rail and detects the light shielding tool at the boundary position, wherein the light shielding tool is supported by the fixed rail in a position after movement between the first moving rail and the second moving rail such that the boundary position is changeable.

According to this type of prize acquisition game device, a service provider (for example, a store clerk or the like) can change the size of the first play area and the second play area at the same time by adjusting the position of the light shielding tool along the fixed rail in the left-right direction.

Furthermore, such a prize acquisition game device may be provided with a control unit that stops the first moving rail at the boundary position in response to the first optical sensor detecting the light shielding tool after movement of the first moving rail along the left-right direction; and the control unit stops the second moving rail at the boundary position in response to the second optical sensor detecting the light shielding tool after movement of the second moving rail along the left-right direction.

According to this type of prize acquisition game device, the movable range of the first prize catcher can be limited in correspondence with the first play area, and the movable range of the second prize catcher can be limited in correspondence with the second play area.

### Embodiments

### <<Configuration of Prize Acquisition Game Device 1>>

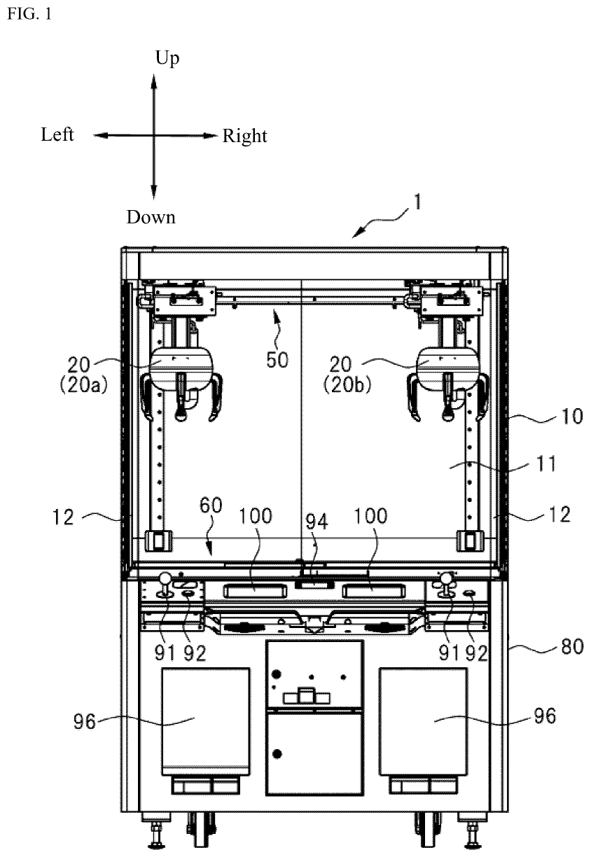

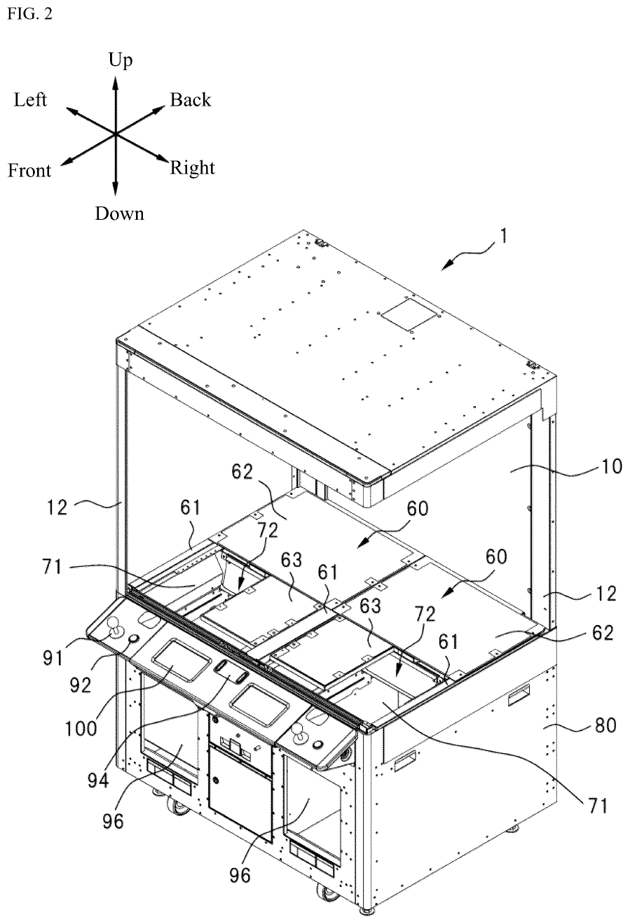

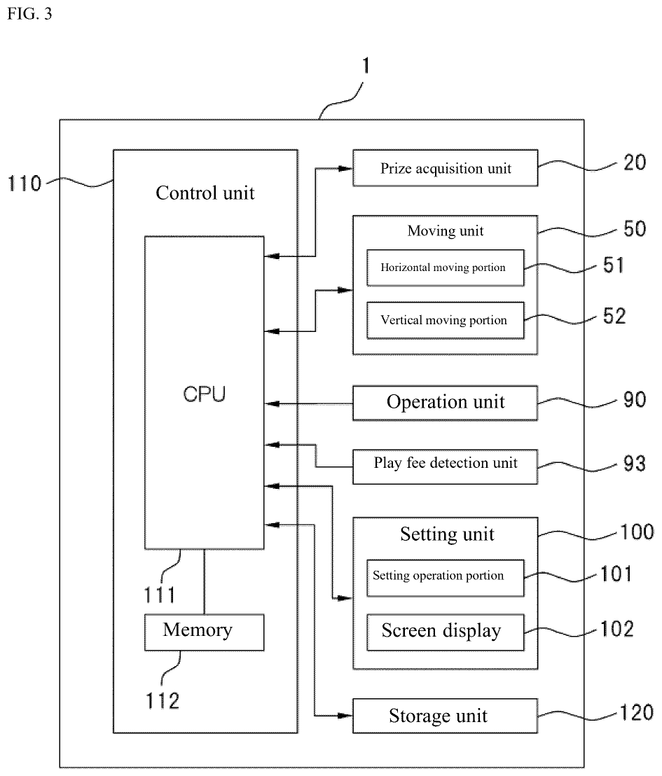

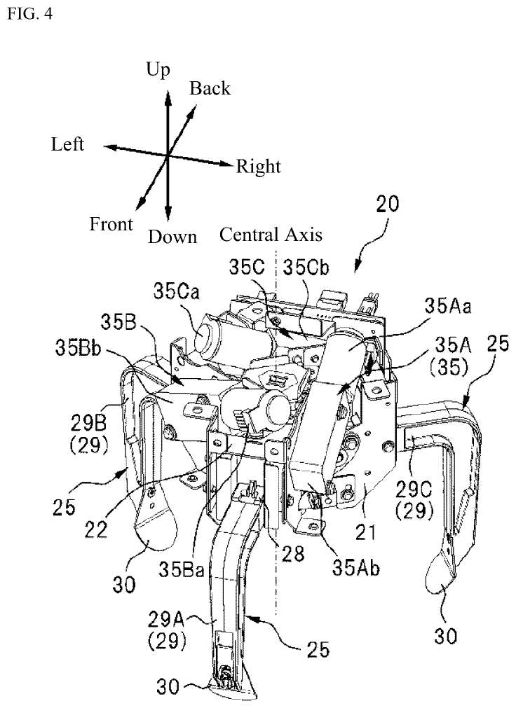

A configuration example of the prize acquisition game device 1 according to one or more embodiments will be described using FIG. 1 to FIG. 4. FIG. 1 is an external view illustrating a configuration of a prize acquisition game device 1 according to one or more embodiments. FIG. 2 is a schematic perspective view illustrating a configuration of a prize acquisition game device 1 according to one or more embodiments. Note that FIG. 2 illustrates a state in which the opening and closing door 11, a part of the pillar portion 12, the prize acquisition unit 20, and the like illustrated in FIG. 1, have been removed. FIG. 3 is a block diagram illustrating a configuration of a prize acquisition game device 1 according to one or more embodiments. FIG. 4 is a schematic diagram illustrating a configuration of a prize acquisition unit 20 according to one or more embodiments. Note that, in addition, FIG. 4 illustrates a state where the design cover of the prize acquisition unit 20 is removed.

In the following description, each direction is defined as illustrated in each FIG. That is, the vertical direction is defined as the “up-down direction,” and “up” and “down” are defined according to gravity. In addition, the front-back directions are defined as the “front” being the front side and the “back” being the back side from the perspective of a player playing the game facing the prize acquisition game device 1. Additionally, the direction perpendicular to the up-down and front-back directions is defined as the “left-right direction,” and “right” and “left” are defined based on the view from the player's side.

The prize acquisition game device 1 of one or more embodiments is used when a player plays a prize acquisition game, and is equipped with a housing portion 10 that stores one or more prizes, and a base portion 80 provided below the housing portion 10.

As illustrated in FIG. 1, the housing portion 10 is formed of transparent members (for example, transparent resin, glass, or the like) on the front surface and the left-right sides so that the prize housed within the housing space can be seen by the player. An opening and closing door 11 is provided on the front of the housing portion 10, allowing a service provider (for example, a store clerk or the like) to display and replenish the prizes. The housing portion 10 has pillar portions 12 provided at its four corners.

The housing space enclosed by the housing portion 10 is used as a play area where a player plays the prize acquisition game. If the pillar portions 12 on both sides of the opening and closing door 11 are made of a mirror-like material or a transparent material, they will not stand out visually, making the play area look wider.

As illustrated in FIG. 1 and FIG. 2, the housing portion 10 in one or more embodiments has a prize acquisition unit 20 that performs the operation of acquiring prizes in the housing space, a moving unit 50 that moves the prize acquisition unit 20 in the housing space, and a display section 60 for displaying the prizes in the housing space.

One or more embodiments form a first play area on the left side of a housing space where a player plays a prize acquisition game, and form a second play area on the right side of the housing space. The prize acquisition unit 20 and the display section 60 are arranged corresponding to the first play area on the left side and the second play area on the right side, respectively. Therefore, within each play area, each prize acquisition unit 20 is configured to move and be able to acquire prizes displayed in each display section 60.

As illustrated in FIG. 1, the prize acquisition unit 20 in this embodiment has a first prize acquisition unit (or first prize catcher) 20a corresponding to the first play area on the left side, and a second prize acquisition section (or second prize catcher) 20b corresponding to the second play area on the right side. The movable range of the first prize acquisition unit 20a within the housing space is limited to within a first play area, and the movable range of the second prize acquisition section 20b within the housing space is limited to within a second play area.

The prize acquisition unit 20 is for acquiring the prizes contained in the housing portion 10 (the prizes displayed in the display section 60) by opening and closing the arm. As illustrated in FIG. 1, the prize acquisition unit 20 in one or more embodiments is configured so as to be able to grasp a prize by means of three arms, and is linked to the lower end of the lifting member 52a.

As illustrated in FIG. 4, the prize acquisition unit 20 in one or more embodiments has a base portion 21 connected to the lower end of the lifting member 52a, a plurality of arm portions 25 that perform opening and closing operations, and a driving unit 35 that drives the arm portions 25 to open and close.

The base portion 21 has trifurcated protruding portions 22 that are offset in three directions at 120 degree intervals from a central axis along the vertical direction.

The arm portion 25 has an arm 29 bent into an L shape and a semicircle shape, an arm linking portion 28 that detachably connects arm 29 to the base portion 21, and a claw 30 that is detachably attached to the tip of the arm 29.

The arm 29 is made up of three arms, a first arm 29A, a second arm 29B, and a third arm 29C, which extend in a trifurcated shape shifted at 120 degree intervals in three directions around the central axis of the base portion 21 so as to match the trifurcated shape of the protruding portion 22.

The driving unit 35 includes three sections, a first driving unit 35A, a second driving unit 35B, and a third driving unit 35C, one for each arm. As illustrated in FIG. 4, the first driving unit 35A, the second driving unit 35B, and the third driving unit 35C correspond to the first arm 29A, the second arm 29B, and the third arm 29C, respectively, and drive them to open and close separately.

The first driving unit 35A has an arm opening and closing motor 35Aa, and a gearbox 35Ab connected to the arm opening and closing motor 35Aa. The gearbox 35Ab reduces the rotational force of the arm opening and closing motor 35Aa and outputs it.

Similarly, the second driving unit 35B has an arm opening and closing motor 35Ba and a gearbox 35Bb connected to the arm opening and closing motor 35Ba, and the third driving unit 35C has an arm opening and closing motor 35Ca and a gearbox 35Cb connected to the arm opening and closing motor 35Ca.

In the prize acquisition unit 20 according to one or more embodiments, for example, when the first arm 29A is in an open state, when the arm opening and closing motor 35Aa rotates the output shaft in a predetermined direction, power is transmitted to the first arm 29A via the gearbox 35Ab, and the first arm 29A rotates in a closing direction. At this time, the second arm 29B and the third arm 29C are also rotated in the closing direction in the same manner by the driving of the arm opening and closing motor 35Ba and the arm opening and closing motor 35Ca, respectively.

As illustrated in FIG. 1, a moving unit 50 is disposed on an upper portion of the inside of the housing portion 10, which moves the prize acquisition unit 20 within the play area formed by the housing portion 10. As illustrated in FIG. 3, the moving unit 50 in one or more embodiments has a horizontal moving portion 51 and a vertical moving portion 52.

The horizontal moving portion 51 moves the prize acquisition unit 20 horizontally (that is, front-back and left-right) on the play area. The vertical moving portion 52 moves the prize acquisition unit 20 in the vertical direction (that is, the up-down direction) on the play area.

The display section 60 is for displaying the prizes in the housing portion 10. The display section 60 according to one or more embodiments is displayed by placing the prize in a housing space, and, as illustrated in FIG. 2, has a support portion 61, a first prize placement section 62 that forms an opening area 71 by being disposed in the housing space, and a second prize placement section 63 that forms a drop port area 72 that closes a portion of the opening area 71 and causes the prize to drop.

The support portion 61 supports the first prize placement section 62 and the second prize placement section 63 so that they can be positioned in the housing space. In one or more embodiments, the first prize placement section 62 is fixed and supported so that it cannot be redisposed within the housing space, and the second prize placement section 63 is supported to enable redisposal within the housing space.

The support portion 61 in one or more embodiments supports the second prize placement section 63 below the first prize placement section 62 in a slidable state. Therefore, by sliding the second prize placement section 63 in the front-back direction, the second prize placement section 63 can be redisposed with respect to the first prize placement section 62, and the shape and size of the placement area where the prize can be placed can be changed, or the shape and size of the drop port area 72 can be changed.

The first prize placement section 62 is fixed within the housing space and its position cannot be changed in principle. As illustrated in FIG. 2, the area (unblocked area) within the housing space where the first prize placement section (fixed prize placement section) is not provided is the opening area 71.

The second prize placement section 63 is configured to be re-deployable within the housing space, and as illustrated in FIG. 2, is supported by the support portion 61 so as to block a portion of the opening area 71 to form the drop port area 72.

When the prize that is acquired and then dropped by the prize acquisition unit 20 passes (drops) through the drop port area 72 of the display section 60, it is considered to have moved from the play area to the base portion 80. The prize dropped from the drop port area 72 of the display section 60 is detected by an optical sensor and then guided to the prize outlet 96 via a guide path. The optical sensor detects the presence or absence of a prize by using a light-emitting element and a light-receiving element that are installed on the guide path.

The base portion 80 is a base portion of a housing provided below the housing portion 10, and holds the housing portion 10 at a high position so that a player can play a game while facing the front in a standing position.

As illustrated in FIG. 1 to FIG. 3, the base portion 80 in one or more embodiments has an operation unit (or operation device/tool) 90, a play fee detector 93, a prize outlet 96, a setting unit 100, a control unit (or hardware processor) 110, and a storage unit 120.

The operation unit 90 allows the player to operate the game. As illustrated in FIGS. 1 to 3, the operation unit 90 in one or more embodiments has at least a joystick 91 and an operation button 92.

The joystick 91 is an operating lever that is used by the player to move the prize acquisition unit 20 in the horizontal direction. The operation button 92 is an operation button used by the player to determine the position of the prize acquisition unit 20 in the horizontal direction. When the operation button 92 is pressed by the player, the prize acquisition unit 20 starts to descend at the determined position.

The play fee detector 93 detects the payment of a play fee by a player. The play fee detector 93 in one or more embodiments has a coin slot 94, a coin detection sensor that is not illustrated, a coin passage path that is not illustrated, and a coin box that is not illustrated.

In one or more embodiments, the prize acquisition game is started when a player inserts a predetermined number of coins into the coin slot 94. A coin inserted through the coin slot 94 is detected by a coin detection sensor.

The coin detection sensor is, for example, an optical sensor, and detects the presence or absence of a coin inserted through the coin slot 94 by a light-emitting portion and a light-receiving portion attached on the coin passage. Coins that have passed through the coin currency path in this manner are stored in the coin box.

The prize outlet 96 is provided on the front surface of the base portion 80 and is for removing a prize that has fallen when the prize acquired by the prize acquisition unit 20 falls through the drop port area 72 in the display section 60.

The setting unit 100 is used when a player performs game operations or the like, or when a service provider performs setting operations. As illustrated in FIG. 1 to FIG. 3, the setting unit 100 in one or more embodiments has a setting operation portion 101 and a screen display 102.

The setting operation portion 101 is for receiving operation input. The setting operation portion 101 in one or more embodiments is configured by a touch panel, and receives input instructions from the operator from the pressing position thereof.

The touch panel is layered on top of the screen display 102, and when a touch operation is performed on the screen, the pressed position (contact position) can be detected based on the change in electrostatic capacitance between the fingertip and the conductive film.

The screen display 102 displays various screens such as a game screen and a setting screen. The screen display 102 in one or more embodiments is configured with a liquid crystal display.

The control unit 110 is provided inside the base portion 80 and is a control unit for carrying out various controls of the prize acquisition game device 1. As illustrated in FIG. 3, the control unit 110 includes at least a CPU 111 and a memory 112.

The CPU 111 is an arithmetic processing device for controlling the entire game device. The memory 112 is used to secure an area for storing instructions such as programs for the CPU 111, a working area, and the like, and includes a storage element such as a RAM.

The storage unit 120 is a unit that stores the instructions and data for the control unit 110 to execute game processing. In one or more embodiments, a memory element such as a ROM which is a read-only memory area is provided.

### <<Configuration of Moving Unit 50>>

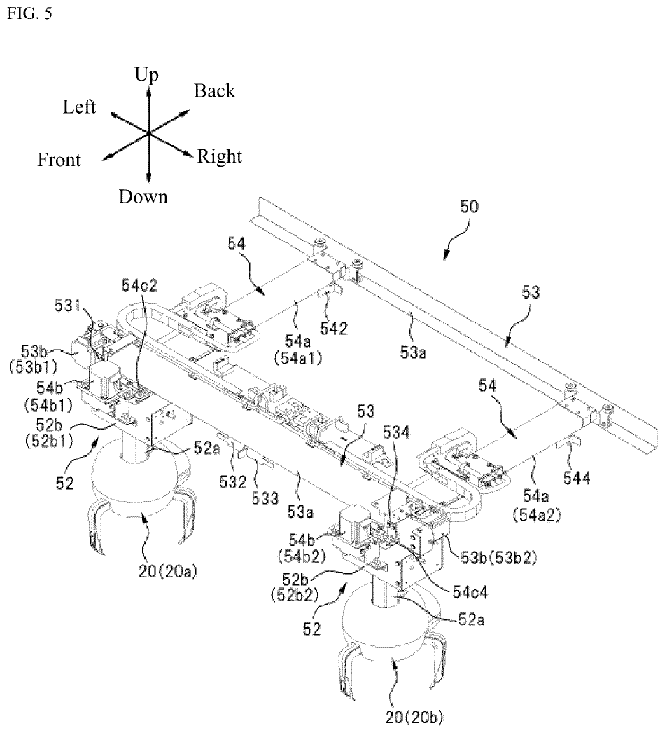

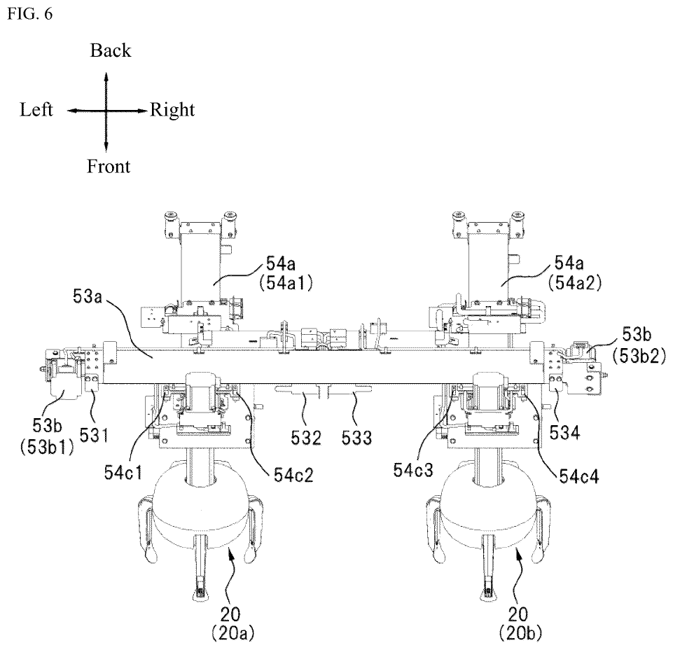

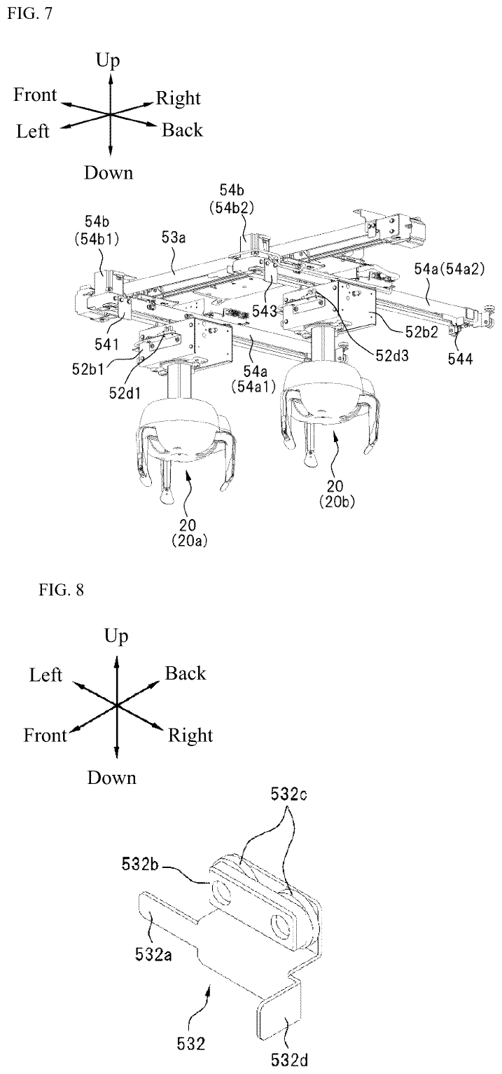

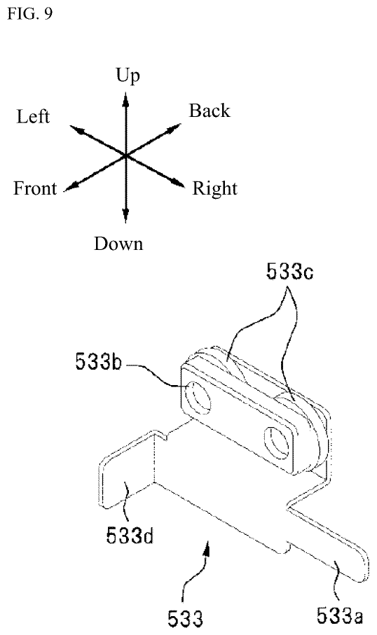

Configuration examples of the moving unit 50 according to one or more embodiments will be described using FIG. 5 to FIG. 9. FIG. 5 is a schematic perspective view illustrating a configuration of a moving unit 50 according to one or more embodiments. FIG. 6 is a planar perspective view illustrating a configuration of a moving unit 50 according to one or more embodiments. FIG. 7 is a right planar perspective view illustrating a configuration of a moving unit 50 according to one or more embodiments. FIG. 8 is a schematic perspective view illustrating a configuration of a first right end operation unit (or first right end light shielding tool) 532 according to one or more embodiments. FIG. 9 is a schematic perspective view illustrating a configuration of a second left end operation unit (or second left end light shielding tool) 533 according to one or more embodiments.

Hereinafter, the configurations of the horizontal moving portion 51 and the vertical moving portion 52 of the moving unit 50 according to this embodiment will be specifically described.

As illustrated in FIG. 5, the horizontal moving portion 51 has a left-right moving portion 53 and a front-back moving portion 54. The left-right moving portion 53 moves the prize acquisition unit 20 left and right on the play area. The front-back moving portion 54 moves the prize acquisition unit 20 front and back on the play area.

As illustrated in FIG. 5, the left-right moving portion 53 in one or more embodiments has a pair of fixed rails 53a extending in the left-right direction within the housing space, and a left-right moving motor 53b that is disposed on both the left and right ends of the fixed rails 53a on the front side.

As illustrated in FIG. 5, the front-back moving portion 54 in this embodiment has a plurality of moving rails 54a extending in the front-back direction within the housing space, and a front-back moving motor 54b arranged at the front end of each moving rail 54a.

As illustrated in FIG. 5, the vertical moving portion 52 has a lifting member 52a configured to be extendable and retractable along the up-down direction, and a suspending member 52b that suspends the lifting member 52a so that it can be raised and lowered. The lifting member 52a is configured by fitting a plurality of pipes of successively smaller diameters in a telescopic manner so as to be freely slidable. The prize acquisition unit 20 is attached to the lower end of the lifting member 52a in a state where it is connected to a wire that passes through the inside of the pipe. The lifting member 52a is attached to the lower end of the suspending member 52b with the prize acquisition unit 20 suspended therefrom. The upper end of the suspending member 52b is supported so as to be freely movable along the front-back direction by the moving rail 54a.

The vertical moving portion 52 according to one or more embodiments, in an inner portion of the suspending member 52b, has a wire winding unit, an up-down movement motor, an upper limit sensor, and a lower limit sensor. The wire winding unit is driven by an up-down moving motor to wind up the wire, thereby raising the prize acquisition unit 20 while sequentially storing the lower pipes in the upper pipe, or to unwind the wire, thereby lowering the prize acquisition unit 20 while sequentially sending out the lower pipes from the upper pipe. The upper limit sensor detects whether or not the rising of the prize acquisition unit 20 has stopped by winding up the wire connected to the prize acquisition unit 20. The lower limit sensor detects whether the lowering of the prize acquisition unit 20 has stopped based on the change in the tension of the wire connected to the prize acquisition unit 20.

The fixed rail 53a according to one or more embodiments extends in the left-right direction across the first play area on the left side and the second play area on the right side which are adjacent to each other on the left and right within the housing space, and as illustrated in FIG. 5, supports a first moving rail 54a1 corresponding to the first play area on the left side and a second moving rail 54a2 corresponding to the second play area on the right side so as to be freely movable along a shared rail.

As illustrated in FIG. 5, a first left-right movement motor 53b1 for moving the first moving rail 54a1 in the left-right direction is disposed on the left end of the front fixed rail 53a. Furthermore, a second left-right movement motor 53b2 for moving the second moving rail 54a2 in the left-right direction is disposed at the right end of the fixed rail 53a on the front side.

The front fixed rail 53a is formed in a U-shaped cross section, and inside it are disposed a first main moving pulley that is rotated by a first left-right movement motor 53b1, a first driven pulley attached to the right end of the front fixed rail 53a, and a first left-right belt that is stretched between the first main moving pulley and the first driven pulley.

Furthermore, inside the front fixed rail 53a, a second main moving pulley rotationally driven by the second left-right moving motor 53b2, a second driven pulley attached to a left end of the front fixed rail 53a, and a second left-right belt hanging between the second main drive pulley and the second driven pulley are disposed.

The first left-right belt and the second left-right belt are disposed so as to be parallel to each other inside the front fixed rail 53a, and the first moving rail 54a1 is connected to the first left-right belt via a first linking portion, and the second moving rail 54a2 is connected to the second left-right belt via a second linking portion.

Therefore, by rotating the first left-right movement motor 53b1 forward or backward, the first moving rail 54a1 linked to the first left-right belt can move back and forth in the left-right direction along the fixed rail 53a. In the same manner, by the second left-right moving motor 53b2 being forward-rotated or reversed, the second moving rail 54a2 connected to the second left-right belt can move back and forth in the horizontal direction along the fixed rail 53a.

In this embodiment, the first moving rail 54a1 supports a first suspending member 52b1, from which is suspended a first prize acquisition unit 20a corresponding to the first play area on the left side, so as to be freely movable in the front-back direction, as illustrated in FIGS. 5 and 7. That is, the first prize acquisition unit 20a is supported by the first moving rail 54a1 so as to be freely movable along the front-back direction.

Similarly, a second suspending member 52b2 from which a second prize acquisition section 20b corresponding to the second play area on the right side is suspended is supported on the second moving rail 54a2 so as to be freely movable in the front-back direction. That is, the second prize acquisition section 20b is supported by the second moving rail 54a2 so as to be freely movable along the front-back direction.

In addition, as illustrated in FIGS. 5 and 7, a first front-back movement motor 54b1 is disposed at the front end of the first moving rail 54a1 for moving the first suspending member 52b1 from which the first prize acquisition unit 20a is suspended in the front-back direction.

Similarly, a second front-back moving motor 54b2 is disposed at the front end of the second moving rail 54a2 for moving the second suspending member 52b2 having the second prize acquisition section 20b suspended in the front-back direction.

The first moving rail 54a1 is formed in a U-shaped cross section, and the main moving pulley rotationally driven by the first front-back moving motor 54b1, the driven pulley attached to a back end of the first moving rail 54al, and the front-back belt hung between the main moving pulley and the driven pulley are disposed inside of the first moving rail 54a1. The first suspending member 52b1 is connected to the front-back belts via a linking portion.

Therefore, by rotating the first front-back movement motor 54b1 forward or backward, the first prize acquisition unit 20a, together with the first suspending member 52b1 connected to the front-back belt, can move back and forth in the front-back direction along the first moving rail 54al.

Similarly, the main moving pulley rotationally driven by the second front-back movement motor 54b2, the driven pulley disposed at a rear end of the second moving rail 54a2, and the front-back belt hung between the main moving pulley and the driven pulley are disposed inside the second moving rail 54a2. The second suspending member 52b2 is connected to the front-back belts via a linking portion.

Therefore, by the second front-back movement motor 54b2 being forward or backward, the second prize acquisition section 20b together with the second suspending member 52b2 connected to the front-back belt can reciprocate in the front-back direction along the second moving rail 54a2.

As illustrated in FIG. 6, a first left end sensor 54c1 that detects the left end position of the first play area is attached to the front left side of the first moving rail 54a1. Then, as illustrated in FIG. 6, a first left end operation unit (or first left end light shielding tool/plate) 531 for activating the first left end sensor 54c1 is attached to the left end of the front fixed rail 53a.

As a result, when the first left end operation unit 531 activates the first left end sensor 54c1 due to leftward movement of the first moving rail 54a1, the first prize acquisition unit 20a together with the first moving rail 54a1 are restricted from moving to the left in the left-right direction in the first play area.

As illustrated in FIG. 6, a first right end sensor 54c2 for detecting a right end position of a first play area is attached to the right front side of the first moving rail 54a1. As illustrated in FIG. 6, the first right end operation unit 532 for activating the first right end sensor 54c2 is supported in the center of the fixed rail 53a on the front side.

Thus, when the first right end operation unit 532 activates the first right end sensor 54c2 due to rightward movement of the first moving rail 54a1, movement of the first prize acquisition unit 20a in the left-right direction in the first play area together with the first moving rail 54a1 is restricted.

As illustrated in FIG. 6, a second left end sensor 54c3 that detects the left end position of the second play area is attached to the front left side of the second moving rail 54a2. As illustrated in FIG. 6, the second left end operation unit 533 for activating the second left end sensor 54c3 is supported in the center of the fixed rail 53a on the front side.

As a result, when the second left end operation unit 533 activates the second left end sensor 54c3 due to leftward movement of the second moving rail 54a2, the second prize acquisition section 20b together with the second moving rail 54a2 are restricted from moving to the left in the left-right direction in the second play area.

As illustrated in FIG. 6, a second right end sensor 54c4 for detecting a right end position of a second play area is attached to the right front side of the second moving rail 54a2. Then, as illustrated in FIG. 6, a second right end operation unit (or second right end light shielding tool/plate) 534 for activating the second right end sensor 54c4 is attached to the right end of the front fixed rail 53a.

Thus, when the second right end operation unit 534 activates the second right end sensor 54c4 due to rightward movement of the second moving rail 54a2, movement of the second prize acquisition section 20b in the left-right direction in the second play area together with the second moving rail 54a2 is restricted.

The first left end sensor 54c1, the first right end sensor 54c2, the second left end sensor 54c3, and the second right end sensor 54c4 are optical sensors that detect the presence or absence of a shielding object based on whether or not the light irradiated from the light emitting unit is received by the light receiving unit. That is, each sensor can detect this when the operation unit comes between the light emitting unit and the light receiving unit.

The first left end operation unit 531 and the second right end operation unit 534 are fixed to the front fixed rail 53a so that their mounting positions cannot be changed in principle. In contrast, the first right end operation unit 532 and the second left end operation unit 533 are supported on the front fixed rail 53a so as to be freely movable in the left-right direction, allowing their mounting positions to be changed (in other words, the right end position of the first play area and the left end position of the second play area can each be changed).

The first right end operation unit 532 is an example of a first operation unit, and is a member that is slidable relative to the front fixed rail 53a. As illustrated in FIG. 8, the first right end operation unit 532 of this embodiment has a shielding unit (or shielding plate) 532a that protrudes to the left in the left-right direction and blocks light emitted from the first right-end sensor 54c2 (first optical sensor), a magnet 532b, two wheels 532c, and a knob portion 532d that protrudes to the front in the front-back direction.

In this embodiment, a concave groove extending in the left-right direction is formed on the inner side surface of the front fixed rail 53a. The front fixed rail 53a supports the first right end operation unit 532 so that the wheels can be placed in the grooves to guide the first right end operation unit 532. A service provider (for example, a store clerk or the like) can operate the knob portion 532d to slide the first right end operation unit 532 left and right along the front fixed rail 53a, thereby changing the position of the first right end operation unit 532 and adjusting the right end position of the first play area. The first right end operation unit 532 can be fixed at a position after being slid by the magnet 532b (after the first right end operation unit 532 is slidably moved, the position can be maintained).

The second left end operation unit 533 is an example of a second operation unit, and is a member that is slidable relative to the front fixed rail 53a. As illustrated in FIG. 9, the second left end operation unit 533 of this embodiment has a shielding unit (or shielding plate) 533a that protrudes to the right in the left-right direction and blocks light emitted from the second left end sensor 54c3 (second optical sensor), a magnet 533b, two wheels 533c, and a knob portion 533d that protrudes to the front in the front-back direction.

In this embodiment, similarly to the first right end operation unit 532 described above, the second left end operation unit 533 is guided by placing its wheels in the grooves of the front fixed rail 53a. The service provider can adjust the left end position of the second play area by sliding the first right end operation unit 532 in the horizontal direction along the front fixed rail 53a and changing the position of the second left end operation unit 533 by operating the knob portion 533d independently of the knob portion 532d of the first right end operation unit 532. The second left end operation unit 533 can be fixed at a position after being slid by the magnet 533b (after the second left end operation unit 533 is slidably moved, the position can be maintained).

In this way, the front fixed rail 53a supports the first right end operation unit 532 at a position after sliding movement between the first moving rail 54a1 and the second left end operation unit 533, thereby making it possible to change the right end position of the first play area, and supports the second left end operation unit 533 at a position after sliding movement between the first right end operation unit 532 and the second moving rail 54a2, thereby making it possible to change the left end position of the second play area.

As illustrated in FIG. 7, a first front end sensor 52d1 that detects the front end position of the first play area is attached to the front end of the first suspending member 52b1. Then, as illustrated in FIG. 7, a first front end operation unit 541 for operating the first front end sensor 52d1 is attached to the front end of the first moving rail 54a1.

As a result, when the first front end operation unit 541 activates the first front end sensor 52d1 due to forward movement of the first suspending member 52b1, the first prize acquisition unit 20a together with the first suspending member 52b1 are restricted in their front-back movement in the first play area.

As illustrated in FIG. 7, a second front end sensor 52b2 that detects the front end position of the second play area is attached to the front end of the second suspending member 52d3. Then, as illustrated in FIG. 7, a second front end operation unit 543 for operating the second front end sensor 52d3 is attached to the front end of the second moving rail 54a2.

As a result, when the second front end operation unit 543 activates the second front end sensor 52d3 due to forward movement of the second suspending member 2, the second prize acquisition section 20b together with the second suspending member 52b2 are restricted in their front-back movement in the second play area.

A first back end sensor (not illustrated) for detecting a back end position of the first play area is attached to the back end of the first suspending member 52b1. Then, as illustrated in FIG. 5, a first back end operation unit 542 for operating the first back end sensor is attached to the back end of the first moving rail 54a1.

As a result, when the first back end operation unit 542 activates the first back end sensor due to backward movement of the first suspending member 52b1, the first prize acquisition unit 20a together with the first suspending member 52b1 are restricted in their front-back movement in the first play area.

A second back end sensor (not illustrated) for detecting a back end position of the second play area is attached to the back end of the second suspending member 52b2. Then, as illustrated in FIG. 5 and FIG. 7, a second back end operation unit 544 for operating the second back end sensor is attached to the back end of the second moving rail 54a2.

As a result, when the second back end operation unit 544 activates the second back end sensor due to backward movement of the second suspending member 52b2, the second prize acquisition section 20b together with the second suspending member 52b2 are restricted in their front-back movement in the second play area.

The first front end sensor 52d1, the first back end sensor, the second front end sensor 52d3, and the second back end sensor are optical sensors that detect the presence or absence of a shielding object based on whether or not the light irradiated from the light emitting unit is received by the light receiving unit. That is, each sensor can detect this when the operation unit comes between the light emitting unit and the light receiving unit.

The first front end operation unit 541 and the first back end operation unit 542 are fixed to the first moving rail 54a1 so that their mounting positions cannot be changed in principle. Similarly, the second front end operation unit 543 and the second back end operation unit 544 are fixed to the second moving rail 54a2 so that their mounting positions cannot be changed in principle.

### <<About Play Area Settings>>

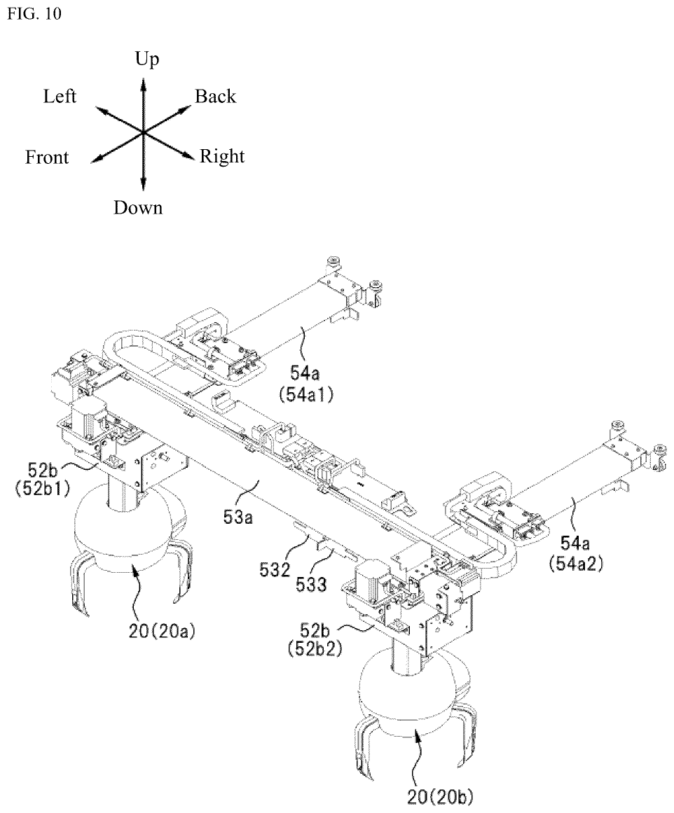

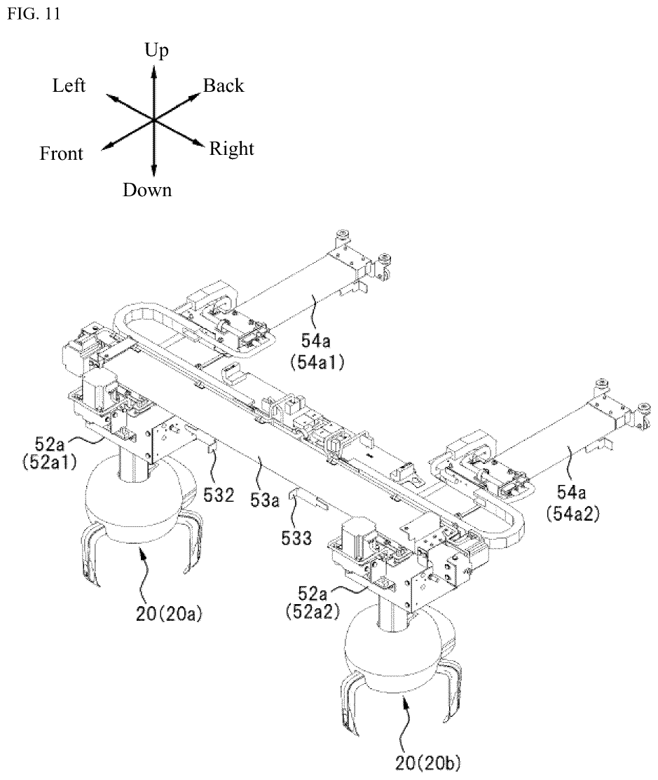

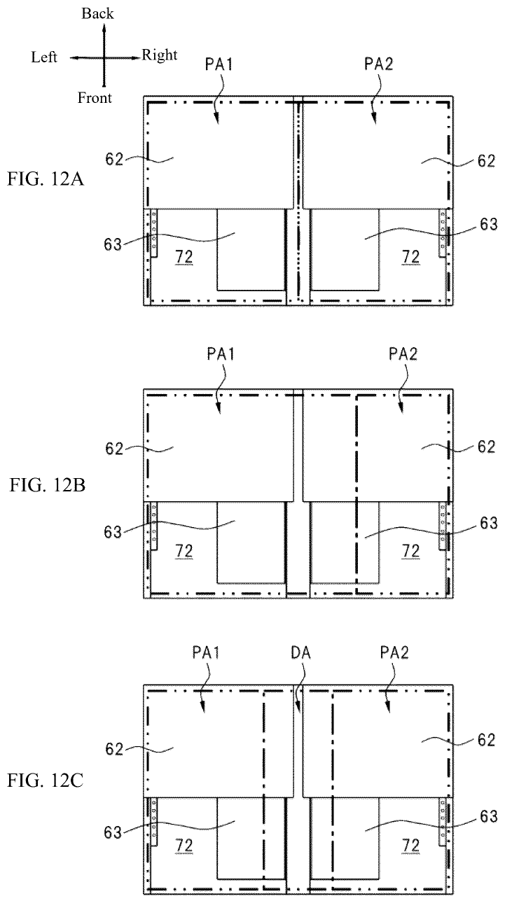

Play area settings according to one or more embodiments will be described using FIG. 10 to FIG. 12C. FIG. 10 is a diagram illustrating a state in which the first right end operation unit 532 and the second left end operation unit 533 have been moved to the right. FIG. 11 is a diagram illustrating a state in which the first right end operation unit 532 has been moved to the left and the second left end operation unit 533 has been moved to the right. FIG. 12A is a diagram explaining the settings of the play areas and illustrating a state in which a first play area PA1 and a second play area PA2 are set to the same size. FIG. 12B is a diagram explaining the settings of the play areas and illustrating a state in which the second play area PA2 is set to be smaller than the first play area PA1. FIG. 12C is a diagram explaining the settings of the play areas and illustrating a state in which a display area DA is set between the first play area PA1 and the second play area PA2. Note that, in the figure, each area is illustrated using a two-dot chain line.

As illustrated in FIG. 5, when the first right end operation unit 532 and the second left end operation unit 533 are moved to the center of the left-right direction of the fixed rail 53a by the operation of a service provider (for example, a store clerk or the like), the right end position of the first play area and the left end position of the second play area will be set to the center of the left-right direction of the fixed rail 53a. In this case, as illustrated in FIG. 12A, the first play area PA1 and the second play area PA2 are the same size. Therefore, the movable ranges of the first prize acquisition unit 20a and the second prize acquisition section 20b within the housing space are also the same size.

Furthermore, when the first right end operation unit 532 and the second left end operation unit 533 are slid from the center in the horizontal direction of the fixed rail 53a to the right direction by the operation of the service provider, the right end position of the first play area and the left end position of the second play area are changed to positions slid from the center in the horizontal direction of the fixed rail 53a to the right direction, as illustrated in FIG. 10. In this case, as illustrated in FIG. 12B, the first play area PA1 is larger than the second play area PA2. Therefore, compared to the state illustrated in FIG. 5, the movable range of the first prize acquisition unit 20a within the housing space is expanded, while the movable range of the second prize acquisition section 20b within the housing space is reduced.

Furthermore, as illustrated in FIG. 11, when, by operation of the service provider, the first right end operation unit 532 slides leftward from the center in the left-right direction of the fixed rail 53a and the second left end operation unit 533 slides rightward from the center in the left-right direction of the fixed rail 53a, the right end position of the first play area will be changed to a position slid leftward from the center in the left-right direction of the fixed rail 53a, and the left end position of the second play area will be changed to a position slid rightward from the center in the left-right direction of the fixed rail 53a. In this case, the fixed rail 53a supports the first right end operation unit 532 and the second left end operation unit 533 so that there is a gap between the right end position of the first play area and the left end position of the second play area, so that a non-play area DA is defined between the first play area PA1 and the second play area PA2, as illustrated in FIG. 12C. Therefore, compared to the state illustrated in FIG. 5, the range of movement of the first prize acquisition unit 20a and the second prize acquisition section 20b within the housing space is reduced, but it is possible to place prizes and decorations for display in the non-play area DA, or to install displays (small monitors) for use in advertising, game explanations, and the like.

### <<Operation of Prize Acquisition Game Device 1>>

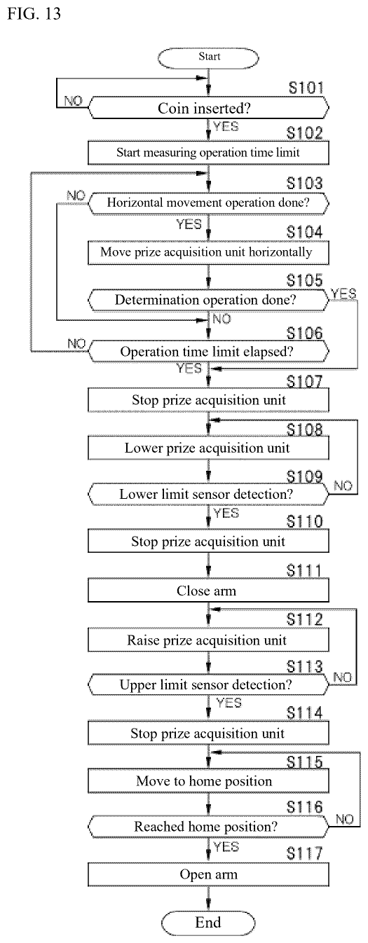

Operation of the prize acquisition game device 1 according to one or more embodiments will be described using FIG. 13. FIG. 13 is a flowchart explaining operation examples of the prize acquisition game device 1 according to one or more embodiments. Below, an example of operation in the first play area will be specifically explained, and an explanation of the second play area will be omitted as it is similar to the first play area.

When the play fee detection unit 93 detects the insertion of a coin (step S101: YES), the control unit 110 starts measuring a preset operation time limit (step S102).

Next, when the control unit 110 receives an operation signal for horizontally moving the first prize acquisition unit 20a by the player operating the joystick 91 (step S103: YES), it drives the horizontal moving portion 51 in accordance with the player's operation to move the first prize acquisition unit 20a horizontally in the first play area (step S104).

In this embodiment, when the first prize acquisition unit 20a is moving horizontally in the first play area, if the first right end operation unit 532 activates the first right end sensor 54c2 due to rightward movement of the first moving rail 54a1, the control unit 110 stops the first prize acquisition unit 20a at the right end position of the first play area. In addition, when the first back end operation unit 542 activates the first back end sensor due to the backward movement of the first suspending member 52b1, the first prize acquisition unit 20a is stopped at the back end position of the first play area. Furthermore, when the first left end operation unit 531 activates the first left end sensor 54cl due to leftward movement of the first moving rail 54a1, the first prize acquisition unit 20a is stopped at the left end position of the first play area. Furthermore, when the first front end operation unit 541 activates the first front end sensor 52d1 by moving the first suspending member 52b1 in the forward direction, the first prize acquisition unit 20a is stopped at the front end position of the first play area.

On the other hand, if the player does not operate the joystick 91 (step S102: NO), the control unit 110 determines whether or not the operation time limit has elapsed (step S106). Then, if the operation time limit has not elapsed (step S106: NO), the process returns to step S103. If the operation time limit has elapsed (step S106: YES), the first prize acquisition unit 20a is stopped (step S107).

Next, when the control unit 110 receives an operation signal for determining the position of the first prize acquisition unit 20a after horizontal movement by the player operating the operation button 92 (step S105: YES), it stops the first prize acquisition unit 20a at the position after the horizontal movement (step S107).

On the other hand, if the player does not operate the operation button 92 (step S103: NO), the control unit 110 determines whether or not the operation time limit has elapsed (step S106). Then, if the operation time limit has not elapsed (step S106: NO), the process returns to step S103. If the operation time limit has elapsed (step S106: YES), the first prize acquisition unit 20a is stopped (step S107).

Next, when the first prize acquisition unit 20a stops (step S107), the control unit 110 drives the vertical moving portion 52 to lower the first prize acquisition unit 20a to the stopping position in the first play area (step S108).

When the lower limit sensor detects that the descent of the first prize acquisition unit 20a has stopped (step S109: YES), the control unit 110 stops the first prize acquisition unit 20a (step S110).

Next, when the first prize acquisition unit 20a is in a stopped state (step S110), the control unit 110 causes the drive unit 35 to rotate the arm portion 25 in a closing direction (step S111).

Next, when the arm portion 25 of the first prize acquisition unit 20a is in a closed state (step S111), the control unit 110 drives the vertical moving portion 52 to raise the first prize acquisition unit 20a (step S112).

When it is detected that the first prize acquisition unit 20a has stopped rising by the upper limit sensor (step S113: YES), the control unit 110 stops the first prize acquisition unit 20a (step S114).

Next, the control unit 110 drives the horizontal moving portion 51 to move the first prize acquisition unit 20a toward the home position (step S115), and determines whether or not the first prize acquisition unit 20a has reached the home position (step S116).

In this embodiment, the control unit 110 determines that the first prize acquisition unit 20a has reached the home position when the first left end operation unit 531 activates the first left end sensor 54c1 due to leftward movement of the first moving rail 54a1, and the first front end operation unit 541 activates the first front end sensor 52d1 due to forward movement of the first suspending member 52b1.

Next, when the first prize acquisition unit 20a is located at the home position (step S116: YES), the control unit 110 causes the drive unit 35 to rotate the arm portion 25 in the opening direction (step S117).

As described above, according to the prize acquisition game device 1 according to the embodiment, the service provider can individually change the size of the first play area and the second play area by adjusting the positions of the first right end operation unit 532 (first operation unit) and the second left end operation unit 533 (second operation unit) in the horizontal direction along the fixed rail 53a. Furthermore, in each of the first play area and the second play area whose size has been changed, it is possible to limit the range of movement within the housing space of each of the first prize acquisition unit 20a and the second prize acquisition section 20b.

### OTHER EMBODIMENTS

The above embodiments are provided to facilitate understanding of the present invention, and are not to be construed as limiting the present invention. The present invention can be modified or improved without departing from the spirit thereof, and the present invention also includes equivalents thereof. In particular, the embodiments described below are also included in the present invention. In other words, the present invention can be configured by appropriately combining the above embodiments with the embodiment described below.

Furthermore, it is also possible to construct various inventions by appropriately combining multiple invention-defining matters disclosed in the above embodiments. For example, the invention may be constructed by deleting some of the invention-defining matters from all of the invention-defining matters disclosed in the above embodiment, or the invention may be constructed by appropriately combining all of the invention-defining matters disclosed in the above embodiment with the invention-defining matters disclosed in the embodiment described below.

### <Prizes>

In the above embodiment, the prizes stored in the housing portion 10 are not limited to items that the player can directly acquire (for example, stuffed toys or the like), but also include items that are stored as targets for acquisition in the game and can be exchanged for other prizes after acquisition, and items that are not provided themselves but are used to compete for points or rankings.

### <Arm>

In the above embodiment, the prize acquisition unit 20 having three arm portions 25 has been described as an example, but the present invention is not limited to this. For example, the present invention can also be applied to an prize acquisition unit 20 having two or less arm portions 25 and an prize acquisition unit 20 having four or more arm portions 25.

### <Movable Operation Unit>

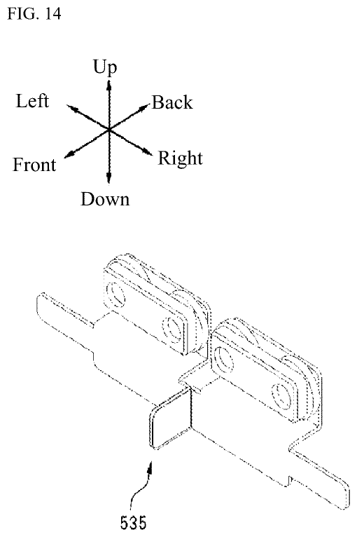

In the above embodiment, an example has been described in which the first right end operation unit 532 (first operation unit) and the second left end operation unit 533 (second operation unit) can each slide along the fixed rail 53a to change their left-right positions. However, the present invention is not limited to this. As illustrated in FIG. 14, an operation unit 535 in which the first right end operation unit 532 (first operation unit) and the second left end operation unit 533 (second operation unit) are integrated may also be used.

In this case, the integrated operation unit 535 is supported by the fixed rail 53a so as to be slidable between the first moving rail 54a1 and the second moving rail 54a2. The first right end sensor 54c2 (first optical sensor) and the second left end sensor 54c3 (second optical sensor) function as sensors that detect the boundary position between the first play area and the second play area. For that purpose, a service provider can change the size of the first play area and the second play area at the same time by adjusting the position of the integrated operation unit along the fixed rail 53a in the left-right direction.

In addition, in the above embodiment, an example has been described in which the first right end operation unit 532 (first operation unit) and the second left end operation unit 533 (second operation unit) each have two wheels, but the present invention is not limited to this. For example, the first right end operation unit 532 (first operation unit) and the second left end operation unit 533 (second operation unit), which do not have wheels, may each be configured to be slidably fitted into a groove on the inside of the front fixed rail 53a.

### <Movable Sensor>

In the above embodiment, the first right end sensor 54c2 (first optical sensor) and the second left end sensor 54c3 (second optical sensor) may each be configured to slide along the fixed rail 53a to change their positions in the left-right direction.

In this case, a first right end operation unit 532 (first operation unit) is attached to the right front side of the first moving rail 54a1 in place of the first right end sensor 54c2, and a second left end operation unit 533 (second operation unit) is attached to the left front side of the second moving rail 54a2 in place of the second left end sensor 54c3. This enables the service provider to individually change the sizes of the first play area and the second play area by adjusting the left-right position of each of the first right end sensor 54c2 (first optical sensor) and the second left end sensor 54c3 (second optical sensor) along the fixed rail 53a.

The first right end sensor 54c2 (first optical sensor) and the second left end sensor 54c3 (second optical sensor) may be integrated into one body.

### <Front End Operation Unit/Rear End Operation Unit>

In the above embodiment, it is also possible to make each of the first front end operation unit 541 and the first rear end operation unit 542 change its position in the front-back direction along the first moving rail 54a1. In the same manner, it is also possible to enable the second front end operation unit 543 and the second rear end operation unit 544 to respectively change their positions in the front-back direction along the second moving rail 54a2.

In this case, for example, a plurality of screw holes are formed at equal intervals along the front-back direction in each of the first moving rail 54a1 and the second moving rail 54a2 so that the front end operation unit and the rear end operation unit can be attached at the changed positions.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### DESCRIPTION OF REFERENCE NUMERALS

1 Prize acquisition game device, 10 Housing portion, 11 Opening and closing door, 12 Pillar, 20 Prize acquisition unit, 20a First prize acquisition section, 20b Second prize acquisition section, 21 Base portion, 22 Protruding portion, 25 Arm portion, 28 Arm linking portion, 29 Arm, 29A First arm, 29B Second arm, 29C Third arm, 30 Claw, 35 Driving unit, 35A First driving unit, 35Aa Arm opening/closing motor, 35Ab Gearbox, 35B Second drive unit, 35Ba Arm opening/closing motor, 35Bb Gearbox, 35C Third drive unit, 35Ca Arm opening/closing motor, 35Cb Gearbox, 50 Moving portion, 51 Horizontal moving portion, 52 Vertical moving portion, 52a Lifting member, 52b Suspending member, 52b1 First suspending member, 52b2 Second suspending member, 52d1 First front end sensor, 52d3 Second front end sensor, 53 Left-right moving portion, 53a Fixed rail, 53b Left-right movement motor, 53b1 First left-right movement motor, 53b2 Second left-right movement motor, 54 Front-back moving portion, 54 Moving rail, 54a1 First moving rail, 54a2 Second moving rail, 54b Front-back movement motor, 54b1 First front-back movement motor, 54b2 Second forward/backward movement motor, 54c1 First left end sensor, 54c2 First right end sensor, 54c3 Second left end sensor, 54c4 Second right end sensor, 60 Display area, 61 Support unit, 62 First prize placement section, 63 Second prize placement section, 71 Opening area, 72 Drop area, 80 Base portion, 90 Operation unit, 91 Joystick, 92 Operation button, 93 Play fee detection unit, 94 Coin insertion slot, 96 Prize removal port, 100 Setting unit, 101 Setting operation portion, 102 Screen display, 110 Control unit, 111 CPU, 112 Memory, 120 Storage unit, 531 First left end operation section, 532 First right end operation section, 532a Shielding unit, 532b Magnet, 532c Wheels, 532d Knob portion, 533 Second left end operation section, 533a Shielding unit, 533b Magnet, 533c Wheels. 533d Knob portion, 534 Second right end operation unit, 535 Operation unit, 541 First front end operation unit, 542 First rear end operation unit, 543 Second front end operation unit, 544 Second rear end operation unit

What is claimed is:

1. A prize acquisition game device, comprising:
a fixed rail that extends in a left-right direction across a left-hand first play area and a right-hand second play area adjacent to each other in a housing space housing a prize;
a first moving rail that extends in a front-back direction orthogonal to the left-right direction and is supported by the fixed rail to be movable along the left-right direction in the first play area;
a first prize catcher that comprises an arm and is supported by the first moving rail to be movable along the front-back direction;
a first sensor that is attached to the first moving rail and detects a right end position of the first play area;
a first light shielding tool that is supported by the fixed rail to be movable along the left-right direction;
a first optical sensor that is attached to the first moving rail and detects the first light shielding tool at a right end position of the first play area;
a second moving rail that extends in the front-back direction and is supported by the fixed rail to be movable along the left-right direction in the second play area;
a second prize catcher that comprises an arm and is supported by the second moving rail to be movable along the front-back direction;
a second light shielding tool that is supported by the fixed rail to be movable along the left-right direction; and
a second optical sensor that is attached to the second moving rail and detects the second light shielding tool at a left end position of the second play area, wherein
the first light shielding tool is supported by the fixed rail at a position after movement between the first moving rail and the second light shielding tool such that the right end position of the first play area is changeable; and
the second light shielding tool is supported by the fixed rail at the position after movement between the first light shielding tool and the second moving rail such that the left end position of the second play area is changeable.

2. The prize acquisition game device according to claim 1, further comprising:
a hardware processor that:
stops the first moving rail at the right end position of the first play area in response to the first optical sensor detecting the first light shielding tool after movement of the first moving rail along the left-right direction; and
stops the second moving rail at the left end position of the second play area in response to the second optical sensor detecting the second light shielding tool after movement of the second moving rail along the left-right direction.

3. The prize acquisition game device according to claim 1, wherein
the fixed rail defines a non-play area between the first play area and the second play area by supporting the first light shielding tool and the second light shielding tool to open an interval from the right end position of the first play area to the left end position of the second play area.

4. The prize acquisition game device according to claim 1, wherein
the fixed rail supports the first light shielding tool and the second light shielding tool in a sliding manner along the left-right direction, and
the first light shielding tool and the second light shielding tool are positioned on the fixed rail by a magnet at positions after slide movement.

5. A prize acquisition game device, comprising:
a fixed rail that extends in a left-right direction across a left-hand first play area and a right-hand second play area adjacent to each other in a housing space housing a prize;
a first moving rail that extends in a front-back direction orthogonal to the left-right direction and is supported by the fixed rail to be movable along the left-right direction in the first play area;
a first prize catcher that comprises an arm and is supported by the first moving rail to be movable along the front-back direction;
a second moving rail that extends in the front-back direction and is supported by the fixed rail to be movable along the left-right direction in the second play area;
a second prize catcher that comprises an arm and is supported by the second moving rail to be movable along the front-back direction;
a light shielding tool that is supported by the fixed rail to be movable along the left-right direction;
a first optical sensor that is attached to the first moving rail and detects the light shielding tool at a boundary position between the first play area and the second play area; and
a second optical sensor that is attached to the second moving rail and detects the light shielding tool at the boundary position, wherein
the light shielding tool is supported by the fixed rail at a position after movement between the first moving rail and the second moving rail such that the boundary position is changeable.

6. The prize acquisition game device according to claim 5, further comprising
a hardware processor that:
stops the first moving rail at the boundary position in response to the first optical sensor detecting the light shielding tool after movement of the first moving rail along the left-right direction, and
stops the second moving rail at the boundary position in response to the second optical sensor detecting the light shielding tool after movement of the second moving rail along the left-right direction.
